(19) United States
(12) Patent Application Publication
(10) Pub. No.: US 2009/0024282 A1
(43) Pub. Date: Jan. 22, 2009

(54) Method for a Preventive-Action Protection System In a Motor Vehicle Having an Inter-Vehicle Distance Sensor System

(75) Inventors: Hans Roehm, Wildberg (DE); Alfred Wagner, Gomaringen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/792,086

(22) PCT Filed: Nov. 30, 2005
(86) PCT No.: PCT/EP05/12761

§ 371 Date: Jul. 31, 2008

(30) Foreign Application Priority Data
Dec. 2, 2004 (DE) 10 2004 058 139.8

(51) Int. Cl. G06F 17/00

(52) U.S. Cl. 701/45

(57) ABSTRACT

A method is provided for a preventive-action protection system in a motor vehicle having an inter-vehicle distance sensor system and having safety devices for lessening the consequences of accidents, wherein driving state data is acquired by means of a driving state sensor system and is monitored, in evaluation stages, with respect to critical states of vehicle movement dynamics (emergency braking, understeering, oversteering, rolling over). As a further triggering condition, a speed threshold has to be exceeded by the vehicle's own speed or preferably by the relative speed measured by the inter-vehicle distance sensor system.

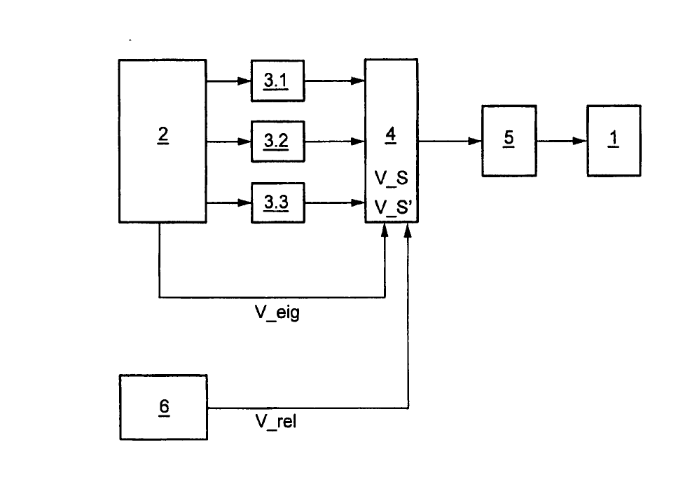

### BACKGROUND AND SUMMARY OF THE INVENTION

The invention relates to a method for a preventive-action protection system in a motor vehicle having an inter-vehicle distance sensor system.

Accordingly, the invention is a preventive-action protection system in a motor vehicle having safety devices for lessening the consequences of accidents, wherein driving state data is monitored with respect to critical states of vehicle movement dynamics (for example emergency braking, understeering, oversteering and rolling over). At least one of the safety devices is triggered if a critical state is determined.

Preventative-action protection systems or so-called PRE-SAFE™ systems are protection systems which are already active in a preventive fashion even before a possible collision and use what is referred to as a pre-crash phase, i.e. a period of time starting from the detection of a high probability of a collision by appropriate detection systems in the vehicle up to the actual impact, to enhance the vehicle occupant protection by means of additional, generally reversible safety measures and thus lessen the severity of an accident. In order to detect possible accident situations, preventive-action protection systems make use of information which is made available by various sensor devices of the motor vehicle. The sensor devices here may also be a component of an electronic driving stability program and/or a component of an inter-vehicle distance sensor system. Depending on the detected situation, conclusions are drawn about a possible accident, and appropriate measures, relating to restraint means for vehicle occupants and possibly protection devices for other parties in an accident, such as pedestrians, are initiated in order to condition the vehicle for the imminent accident.

German Patent Document DE 101 21 386 C1 discloses a method for actuating a reversible vehicle occupant protection means in a motor vehicle. The motor vehicle here has a reversible vehicle occupant protection system which can be activated before a collision time and thus moved into an effective position. For this purpose, a sensor system is used to acquire driving state data which is monitored for any possible emergency braking, any possible oversteering and any possible understeering. If emergency braking, oversteering and/or understeering are detected, the vehicle occupant protection system is activated, in which case further conditions may be provided for the triggering operations. Such a condition is that the vehicle occupant protection system is actuated only if the vehicle is at a minimum speed. This has the advantage that the vehicle occupant protection system is prevented from being actuated at low speeds at which there is in any case no risk to vehicle occupants.

German Patent Document DE 43 32 205 C2 discloses a vehicle occupant protection system with an acceleration sensor in which a seat belt pretensioner, a powered seat belt pretensioner and an airbag are placed in a state of operational readiness as a function of a respectively assigned vehicle speed. Triggering occurs when the longitudinal dynamics are critical. Given severe braking deceleration, pretensioning of a seat belt may occur, while the powered pretensioning or the triggering of an airbag occurs only when there is an impact, provided that the associated thresholds for the vehicle speed are likewise exceeded. Critical lateral vehicle movement dynamics are not discussed in the document.

The invention solves the following problem:

The activation of protection measures is appropriate only when there is a certain degree of severity of an accident. The degree of severity of an accident correlates to the vehicle's own speed only in the case of a stationary collision object. For this case it is actually appropriate to trigger the protection measures only starting from a defined vehicle speed (above approximately 30 km/h), as is disclosed in DE 101 21 386 C1.

However, if there is an oncoming vehicle approaching at a considerable speed, a highly severe accident may be caused even when the vehicle's own speed is low. On the other hand, when the vehicle's own speed is high a low degree of severity of an accident may occur if the other party in the accident is a vehicle traveling ahead at a slightly lower speed. In these two cases, the vehicle's own speed is unsuitable for defining an activation threshold.

Exemplary embodiments of the invention provide an improved method for a preventive-action protection system of the type mentioned at the beginning which is better adapted to all the traffic situations which occur.

With the method according to the invention it is possible to react better to real driving states by virtue of the fact that the relative speed in relation to a collision object is determined in advance of an imminent accident, and this relative speed is used to define an activation threshold. This requires an inter-vehicle distance sensor system in the vehicle.

Such inter-vehicle distance sensor systems are well known from the prior art. The surroundings of the vehicle are sensed using ultrasonic waves, radar waves, optical waves, infrared waves or other suitable waves and an imminent collision is concluded from the measured distance and the measured relative speed.

The critical states in terms of vehicle movement dynamics which are specified below are by way of example and can be readily supplemented. In particular, a separate speed threshold can be assigned to each critical state of vehicle movement dynamics comprising emergency braking, understeering, oversteering and rolling over, in order to avoid undesired incorrect triggerings. The speed thresholds are typically in the range of 30-40 km/h.

The sensor system for sensing driving state data can comprise a steering angle sensor, a pedal travel sensor, a brake pressure sensor, a wheel speed sensor, an acceleration sensor (longitudinal and a lateral acceleration) and a yaw rate sensor. In order to sense rollover it is possible for spring travel sensors, vehicle body acceleration sensors, ride level sensors or axle rotational angle sensors to be additionally evaluated in a known fashion in order to detect an imminent rollover process in which the vehicle partially lifts off the underlying road surface and tilts.

With respect to the detection of the state of emergency braking, DE 101 21 386 C1 discloses such detection. The emergency braking occurs if a braking process occurs with at least one feature which indicates a hazardous situation or emergency situation. The state of emergency braking is determined by using at least one of the parameters of brake pressure, speed of the activation of the brake pedal and speed of withdrawal of the driver's foot from the accelerator pedal to evaluate the braking process. In particular, the state of emergency braking can be detected by reference to intervention by a braking assistance system into the vehicle movement dynamics by virtue of the fact that, for example, an information signal which is transmitted onto a databus by the braking assistance system is used to detect the state of emergency braking. The state of emergency braking can also comprise what is referred to as panic braking in which an emergency situation is indicated by a slow but powerful activation of the brakes.

The states of oversteering and understeering indicate critical lateral vehicle movement dynamics. According to DE 101 21 386 C1, these critical states are determined by virtue of the fact that, for example, the difference is evaluated from an angle which describes the actual change in the direction of travel, and from the steering angle. For the algorithm, reference should be made to DE 101 21 386 C1. Other methods can also be used additionally or alternatively to determine imminent critical lateral dynamics by virtue of the fact that, for example, a set point/actual value comparison is not carried out but instead the steering wheel activation, in particular the steering angle speed, which is predefined by the driver is evaluated.

Critical longitudinal dynamics can also be sensed by means of a directly measuring acceleration sensor which senses strong braking deceleration processes or lateral forces which act on the vehicle and corresponding forces acting on the vehicle occupant, as described in DE 43 32 205 C2. The impact itself is also sensed with an acceleration sensor and can also be considered, in the sense of the invention, as a critical state of vehicle movement dynamics. In an analogous fashion, critical lateral vehicle movement dynamics and a side impact could be sensed by means of a lateral acceleration sensor.

The method can be advantageously extended by using different speed thresholds for the vehicle's own speed and for the relative speed, respectively. In this way it is possible to take into account the fact that when a signal for the relative speed is present the probability of an impact is very much higher than if an imminent accident is inferred merely from the presence of a critical situation in terms of vehicle movement dynamics.

In one extension of the method, different speed thresholds can be assigned to the different critical states of vehicle movement dynamics. As a result, the preventive triggering can be adjusted better to the various critical situations in terms of vehicle movement dynamics, as a result of which undesired early triggering is avoided.

In addition to the known restraint systems which can be triggered in a preventive fashion, such as the reversible seat belt pretensioner of a seat belt, there are a series of further controllable vehicle occupant protection means which generate a restraining effect or an energy-absorbing effect in order to protect a vehicle occupant in the event of a collision. Examples of such vehicle occupant protection means are movable impact elements, cushions and head rests which can be changed in terms of size, hardness, shape and position by actuation means. In addition to these vehicle occupant protection means, it is possible to provide further controllable protection means for lessening the severity of an accident, said protection means lessening the consequences of an accident for a vehicle occupant by virtue of the fact that electrically adjustable assemblies which are originally provided for comfort purposes, for example electric seat adjustment device or an electric adjustment device for vehicle openings (window lifter, sunroof closing means) or door lock systems, are actuated.

In order to lessen the consequences of accidents it is also possible to provide controllable protection means in motor vehicles which also serve to protect other parties in a collision, in particular to protect pedestrians and cyclists. Examples of such controllable protection means are adjustable engine hoods, movable bumpers and impact elements with adjustable hardness on the outer skin of the vehicle. Further controllable protection means are the ride level control and the brake and steering system by means of which an impact can be optimized in the direction of less severe injury to the vehicle occupants and/or the other parties in the collision. These protection means are also to be understood below as safety devices within the sense of the present invention.

The present invention constitutes an advantageous addition to a vehicle with an inter-vehicle distance sensor system in which an emergency braking process is initiated automatically just before the impact which is certain to occur. With the invention the preventive-action protection system can already react adequately in advance to critical driving states of vehicle movement dynamics which often precede an impact.

### BRIEF DESCRIPTION OF THE DRAWING FIGURE

The single FIGURE shows by way of example a block circuit diagram of a preventive-action protection system in a motor vehicle for carrying out an advantageous embodiment of the method according to the invention.

### DETAILED DESCRIPTION

In order to actuate the preferably reversible safety devices 1, the driving state data recorded by the driving state sensor system 2 is monitored in evaluation stages 3.1-3.3 with respect to the driving states of emergency braking in 3.1, understeering in 3.2 and oversteering in 3.3. With respect to the evaluation methods used, reference is made to DE 101 21 386 C1. It is thus checked, for example, whether the signal of a brake pedal travel sensor indicates an activation speed above a threshold. In this case, a state of emergency braking is detected and the output of the stage 3.1 is set to logic “1”, and otherwise the output remains at logic “0”. The same applies to the other evaluation stages 3.2 and 3.3 for the cases of understeering or oversteering.

The logic signals from the evaluation stages 3.1-3.3 are logically combined in a decision stage 4 with the result of a threshold interrogation in which the vehicle's own speed v_eig, which is supplied by the driving state sensor system 2, or preferably, i.e. such a signal is to be used if it is present, the relative speed v_rel which is supplied by the inter-vehicle distance sensor system 6, is compared with a speed threshold V_S. The logic signal is passed onto the triggering logic 5 only if the speed threshold V_S is succeeded by the vehicle's own speed v_eig or preferably by the relative speed v_rel. In one advantageous embodiment, different speed thresholds V_S and V_S′ can be used for the vehicle's own speed v_eig and for the relative speed v_rel, respectively.

Triggering logic 5 decides which of the safety devices are triggered depending on the current critical driving state, in which case the direction from which a hazard could originate can also be taken into account. In this regard also, reference is made to DE 101 21 386 C1, in which the acquired information and the selected protection strategy can be improved by suitably sensing the surroundings. U.S. Pat. No. 7,178,622 is a family member of German Patent Document DE 101 21 386 C1, and this U.S. patent is herein expressly incorporated by reference.

Instead of logic combinations of the results of the various evaluations with the threshold interrogations, comparable behavior of the protection system can be brought about by providing means of appropriately influencing the triggering threshold or forming an overall criticality, which is dependent in a multifactorial fashion on the vehicle data, assumes a value between 0 . . . 1 and has to overcome a fixed threshold at, for example, 0.8 for a safety device to be triggered (Fuzzy Logic). Although such alternatives permit a relatively soft transition behavior, they constitute well known equivalent technical designations of the threshold interrogations described.

1-5. (canceled)

6. A method for a preventive-action protection system in a motor vehicle having safety devices for lessening the consequences of accidents, the method comprising the acts of:
acquiring driving state data by a driving state sensor system;
monitoring, in evaluation stages, the acquired driving state data with respect to critical states of vehicle movement dynamics; and
triggering at least one of the safety devices when a critical state of vehicle movement dynamics is determined and in a further triggering condition a speed threshold is exceeded by the vehicle's own speed,
wherein when the vehicle detects an imminent impact by means of an inter-vehicle distance sensor system and determines a relative speed in relation to a collision object, and at the same time a critical state of a vehicle movement dynamics is sensed, the further triggering condition is replaced by a condition in which a speed threshold has to be exceeded by the relative speed for at least one of the safety devices to be triggered.

7. The method as claimed in claim 6, wherein the critical states comprise at least one of the states of emergency braking, understeering, oversteering and rolling over.

8. The method as claimed in claim 6, wherein the speed threshold for the relative speed is lower than the speed threshold for the vehicle's own speed.

9. The method as claimed in claim 6, wherein the speed threshold is between 30-40 km/h.

10. The method as claimed in claim 8, wherein the speed threshold is between 30-40 km/h.

11. The method as claimed in claim 6, wherein the safety devices are reversible and comprise in particular a reversible seat belt pretensioner.
